(19) United States
(12) Patent Application Publication
(10) Pub. No.: US 2023/0391974 A1
(43) Pub. Date: Dec. 7, 2023

(54) HEAT RELEASE CONTROLLED STRUCTURES

(71) Applicant: Bright Lite Structures LLC, San Francisco, CA (US)

(72) Inventor: Antony DODWORTH, Stamford (GB)

(21) Appl. No.: 18/248,843

(22) PCT Filed: Oct. 12, 2021
(86) PCT No.: PCT/US2021/054535

§ 371 Date: Apr. 12, 2023

Related U.S. Application Data
(60) Provisional application No. 63/092,899, filed on Oct. 16, 2020.

(51) Int. Cl. C08J 9/228; C08J 9/00; B29C 41/00; B29C 41/08; B29C 41/52; B29C 41/38

(52) U.S. Cl. CPC C08J 9/228; C08J 9/0066; B29C 41/003; B29C 41/08; B29C 41/52; B29C 41/38; C08J 2375/04; B29K 2075/00

(57) ABSTRACT

Embodiments of the invention relate to composite structures and foams having graphene flakes on at least one outer surface but not in the intermediate portions thereof, methods of making the foams, composite laminate structures having the foams, methods of making composite laminate structures having the foams, laminate structures having graphene flakes on at least one outer surface thereof; and methods of making laminate structures having graphene flakes on at least one outer surface thereof. The composite structures and foams having graphene flakes on an outer surface thereof provide relatively low heat release properties compared to those not having graphene flakes on an outer surface thereof.

### CROSS-REFERENCE TO RELATED APPLICATIONS

This application claims priority to U.S. Provisional Patent Application No. 63/092,899 filed on 16 Oct. 2020, the disclosure of which is incorporated herein, in its entirety, by this reference.

### BACKGROUND

Polymer foams are used in a variety of applications, such as structural foams, insulation foams, furniture foams, or the like. Such foams may be prone to ignition, emitting toxic chemicals and smoke, or releasing heat. Accordingly, nearly all foam used in households today must be fire retardant. Many foams, such as structural foams, may not be permitted to be used in strictly regulated environments such as aerospace, automotive, marine, rail, or other industrial applications. For example, strict fire, smoke, and toxicity standards may prevent the use of specific foams in composite laminate structures used in train seats, commercial aerospace seats, automotive panels, or the like. Similarly, heat release of foams prevents many foams from being used in applications where heat release in components is strictly regulated.

Typically, fire retardant material is utilized throughout the foams to prevent heat release, ignition, or emission of smoke and toxins. For example, a foam may be made with a fire retardant component dispersed throughout the polymer thereof. Or a fire resistant polymer may be utilized. However, the flame resistant polymer may not have as desirable of mechanical properties as polymer foams that do not meet fire, smoke, and toxicity (“FST”) standards or heat release standards. For example, by adding flame retardant or other additive(s) to the foam, the mechanical performance of the foam may be reduced.

### SUMMARY

Embodiments of the invention relate to foams having a graphene flakes on at least one outer surface thereof, methods of making the foams, composite laminate structures having the foams, methods of making composite laminate structures having the foams, laminate structures having graphene flakes on at least one outer surface thereof; and methods of making laminate structures having graphene flakes on at least one outer surface thereof.

In an embodiment, a heat release foam is disclosed. The heat release foam includes a polymer foam body defining one or more outer surfaces disposed around an intermediate portion. The heat release foam includes a layer including graphene flakes located on at least one of the one or more outer surfaces, wherein the intermediate portion is substantially free of graphene flakes.

In an embodiment, a method of making a heat release foam is disclosed. The method includes applying a plurality of graphene flakes onto at least one molding surface of a mold. The method includes depositing an uncured polyurethane foam in the mold. The method includes curing the polyurethane foam in the mold.

In an embodiment, a composite structure is disclosed. The composite structure includes a first fiber layer having a first plurality of fibers and a first polymer resin. The composite structure includes a core disposed on the first fiber layer, the core including a polymer foam body and a layer including graphene flakes, the polymer foam body defining one or more outer surfaces disposed around an intermediate portion, wherein the layer including graphene flakes is located on at least one of the one or more outer surfaces, wherein the intermediate portion is substantially free of graphene flakes.

In an embodiment, a method of making a heat release controlled composite structure is disclosed. The method includes forming a lay-up including a first fiber layer disposed on a core, the first fiber layer having a first plurality of fibers and a first polymer resin thereon, and the core including a polymer foam body and a layer including graphene flakes, the polymer foam body defining one or more outer surfaces disposed around an intermediate portion, wherein the layer including graphene flakes is located on at least one of the one or more outer surfaces, wherein the intermediate portion is substantially free of graphene flakes. The method includes pressing the lay-up in a mold. The method includes at least partially curing the polymer resin to form a composite part.

In an embodiment, a composite laminate structure is disclosed. The composite laminate structure includes a first fiber layer including a first plurality of fiber and a first polymer resin thereon. The composite laminate structure includes a second fiber layer including a second plurality of fibers and a second polymer resin thereon. The composite laminate structure includes an outer polymer layer disposed on the first fiber layer, the outer polymer layer including an outer polymer having a plurality of graphene flakes disposed therein.

In an embodiment, a method of making a heat release controlled composite structure is disclosed. The method includes forming a lay-up including a first fiber layer having a first plurality of fibers and a first polymer resin thereon, a second fiber disposed under the first fiber layer, the second fiber layer having a second plurality of fibers and a second polymer resin thereon, and an outer polymer layer disposed on the first fiber layer, the outer polymer layer having an outer polymer resin including a plurality of graphene flakes therein. The method includes pressing the lay-up in a mold. The method includes at least partially curing the lay-up to form a composite part.

In an embodiment, a heat release controlled structure is disclosed. The heat release controlled structure includes at least one material having graphene flakes on an outer surface thereof and being substantially free of graphene flakes on a portion thereof interior to the outer surface.

Features from any of the disclosed embodiments may be used in combination with one another, without limitation. In addition, other features and advantages of the present disclosure will become apparent to those of ordinary skill in the art through consideration of the following detailed description and the accompanying drawings.

### BRIEF DESCRIPTION OF THE DRAWINGS

The drawings illustrate several embodiments of the invention, wherein identical reference numerals refer to identical or similar elements or features in different views or embodiments shown in the drawings.

FIG. 1 is an isometric view of a heat release foam, according to an embodiment.

FIG. 2 depicts a block of applying a plurality of graphene flakes onto at least one molding surface of a mold, according to an embodiment.

FIG. 3 depicts a block of depositing an uncured polyurethane foam in the mold of FIG. 2, according to an embodiment.

FIG. 4 depicts block of curing the polyurethane foam in the mold of FIG. 2, according to an embodiment.

FIG. 5 is an isometric view of a composite laminate structure, according to an embodiment.

FIG. 6 is flow diagram of a method for making a heat release controlled composite structure, according to an embodiment.

FIG. 7 is an isometric view of a lay-up being placed into a mold, according to an embodiment.

FIG. 8 shows a seatback formed from the lay-up in the mold of FIG. 7, according to an embodiment.

FIG. 9 is a cross-sectional view of a composite laminate, according to an embodiment.

FIG. 10 is a flow diagram of a method for making a heat release controlled composite structure, according to an embodiment.

FIG. 11 is a photo of a heat release foam part of working example A.

### DETAILED DESCRIPTION

Embodiments of the invention relate to composite structures and foams having a graphene flakes on at least one outer surface thereof, methods of making the composite foams, composite laminate structures having the foams, methods of making composite laminate structures having the foams, laminate structures having graphene flakes on at least one outer surface thereof; and methods of making laminate structures having graphene flakes on at least one outer surface thereof. Foams, such as polyurethane foams, may be utilized as structural component in parts for automotive, aircraft, marine, rail, and other applications. For example, composite laminate parts may utilize the foam having the outer layer(s) including graphene flakes as a core or other layer(s) to achieve relatively low heat release values.

By utilizing graphene flakes on an outer layer of the foam, heat release is lowered and delayed when the foam is exposed to flame. The graphene flakes disclosed herein transfer heat in-plane throughout the sp² carbon structure of each graphene flake, thereby retaining absorbed heat. By locating the graphene flakes only on one or more surfaces of the foam, a selected heat release value for the foam or composite laminate having the foam may be achieved, while avoiding the high costs of having graphene throughout the entire foam. Further, graphene is difficult to uniformly disperse in a polymer foam. Therefore, the costly and time intensive efforts to disperse graphene into a foam may be avoided without sacrificing heat release values for the resulting foam having an outer layer including graphene flakes.

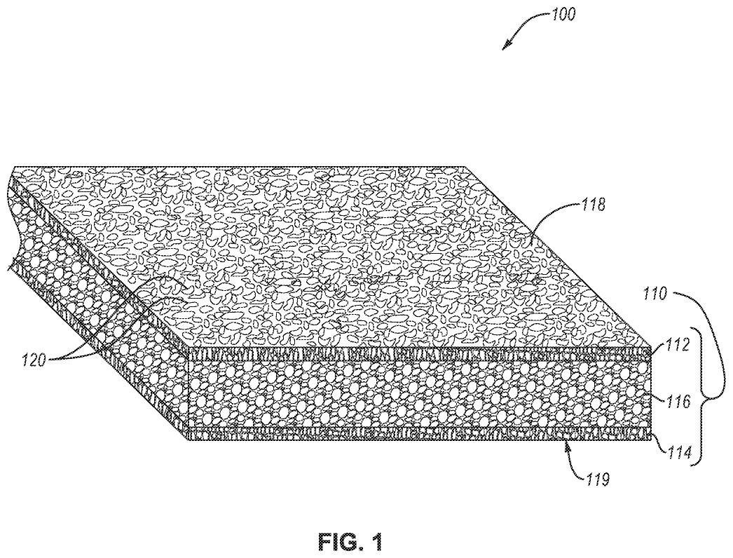

FIG. 1 is an isometric view of a heat release foam 100, according to an embodiment. The heat release foam 100 includes a polymer foam body 110 defining one or more outer surfaces 118 and 119 disposed around an intermediate portion 116. For example, the polymer foam body 110 may be substantially planar with the first outer surface 118 being substantially opposite the second outer surface 119 and the intermediate portion 116 is disposed between. The heat release foam 100 includes at least one layer including graphene flakes located on at least one of the one or more outer surfaces 118 and 119. For example, the at least one layer including graphene flakes may be disposed in a first layer including graphene flakes 112 on the first outer surface 118. Optionally, the heat release foam 100 may include a second layer including graphene flakes 114 on the second outer surface 119. The intermediate portion 116 is substantially free of graphene flakes.

The polymer foam body 110 may include a foam of one or more polymers, such as one or more of a polyurethane, a polyisocyanurate (“PIR”), a polystyrene (e.g., expanded polystyrene foam), polycarbonate, poly(butylene terephthalate) (“PBT”), polyphenylene ether (PPE), polyethylene, polyvinyl chloride, vinyl esters, or the like. The polymer foam of the foam body may be an expandable foam. The polymer foam body 110 may be an open celled foam or a closed cell foam. The density of the polymer foam my vary. Suitable densities may range from about 0.25 kg/m³ to about 200 kg/m³. For example, the polymer foam body 110 may have a density of about 0.25 kg/m³ to about 20 kg/m³, about 15 kg/m³ to about 30 kg/m³, about 30 kg/m³ to about 60 kg/m³, about 60 kg/m³ to about 100 kg/m³, about 100 kg/m³ to about 150 kg/m³, about 150 kg/m³ to about 200 kg/m³, less than about 200 kg/m³, less than about 100 kg/m³, less than about 75 mg/m³, less than about 50 mg/m³, or more than about 0.25 kg/m³.

The polymer foam body 110 may be made or provided as a substantially planar sheet. In some examples, the polymer foam body 110 may be provided in any desired shape. In such examples, the polymer foam body 110 may be formed in a mold, wherein the foam is inserted into the mold to fill the mold (e.g., through filling the mold or expansion).

The polymer foam body 110 includes at least one layer including graphene flakes (112, 114) disposed on one or more of the outer surfaces 118 or 119. The first layer including graphene flakes 112 may be disposed on the first outer surface 118 and the second layer including graphene flakes 114 may be disposed on the second outer surface 119. The layer(s) including graphene flakes may be on or bound to the polymer foam at the outer surface(s). While described as “layers” being located on the one or more outer surfaces of the foam body, the graphene flakes 120 in the at least one layer including graphene flakes (112, 114) penetrate into the polymer foam a relatively minimal distance from the respective outer surface(s) 118 and 119. Accordingly, the at least one layer including graphene flakes (112, 114) is part of the polymer foam body 110 but differs in composition from other portions of the polymer foam body 110 due to the presence of the graphene flakes 120. The thickness of the at least one layer including graphene flakes (112, 114)—depth into the polymer foam body 110 that the graphene flakes penetrate—may be less than about 1 cm, less than about 5 mm, less than about 3 mm, less than about 2 mm, less than about 1 mm, about 1 μm to about 500 μm, about 1 nm to about 1 mm, about 1 μm to about 2 mm, or more than about 10 μm. Such graphene flakes 120 are referred to as on the outer surface or layers on the outer surface of the polymer foam body 110 for the purposes of this disclosure. Accordingly, unless otherwise explicitly stated, the layers of or including graphene flakes disclosed herein may include graphene flakes 120 that have penetrated into the polymer foam body a minimal distance, graphene flakes 120 that have not penetrated into the polymer foam body (e.g., are bound to the polymer body at the outer surface), or both. The thicknesses of the layer(s) including graphene flakes may be average thicknesses of the layer(s) due to variations in the thickness and concentration of graphene flakes in one or more portions of the respective layer(s) including graphene flakes.

By limiting the penetration of the graphene flakes 120 into the intermediate portion 116, the heat release properties of the graphene flakes 120 are concentrated at the outer surface(s) of the polymer foam body 110. The intermediate portion 116 is substantially free of graphene flakes 120, such as having, at most, less than 5 percent of the amount (e.g., concentration) of graphene flakes found in the at least one layer including graphene flakes (112 or 114), such as less than 3 percent, less than 1 percent of the amount graphene flakes found in the at least one layer including graphene flakes, or only a trace amount of graphene flakes.

While the graphene flakes 120 are located in the at least one layer including graphene flakes (112, 114), the graphene flakes may not be uniformly distributed therethrough. For example, depending upon the flow of polyurethane (or other polymer) resin into a mold having the graphene flakes 120 thereon, the graphene flakes 120 may be more concentrated in some regions of the foam body 110 than others, such as in corners of the foam body or areas away from injection points of the mold used to form the heat release foam 100. In such areas, the thickness(es) of the at least one layer including graphene flakes (112, 114) may be greater than in other areas of the foam body 110. For example, at a thinner portion of a foam body 110, the thickness of the at least one layer including graphene flakes (112, 114) may be greater than in other more voluminous areas due to turbulence created in the mold in the thinner areas during injection of the polymer resin. Accordingly, at least a portion of the heat release foam 100 may at least include one or more portions where the at least one layer including graphene flakes (112, 114) is disposed over a portion of foam body 110 that is substantially free of graphene flakes 120. The heat release foam 100 may also include one or more portions wherein the at least one layer including graphene flakes (112, 114) are not disposed over a portion of foam body 110 having substantially no graphene flakes therein. It is currently believed that the non-uniform distribution of graphene flakes in the at least one layer including graphene flakes (112, 114) does not substantially affect the heat release properties of the heat release foam 100 (e.g., a composite laminate with the foam still produce a heat release value of less than about 50, 40, or 30 kw Min/m² for at least two minutes under United States Federal Aviation Regulation (“FAR”) 25.853 test conditions). For example, one component of a part (e.g., seatback) may be monolithic and another component of the part may be a composite laminate (e.g., sandwich structure) having the heat release foam therein. In such examples, the part, as a whole, may exhibit heat release below 50, 40, or 30 kw Min/m² for at least two minutes as disclosed herein.

Graphene flakes 120 herein differ from graphene sheets, graphene powder, carbon nanotubes, fullerenes and the like. Graphene flakes 120 are multilayered graphene structures that have a substantially planar confirmation with a surfaces defined by a number of folds, discontinuities, differences in the number of layers, or ridges, with an irregular lateral surface geometry that results in graphene flakes resembling flakes of breakfast cereal, on a smaller scale. Accordingly, the graphene flakes 120 have multiple layers of graphene (graphene sheets) as is often found in graphene powders, carbon nanotubes, or fullerenes. The graphene flakes are formed by depositing (e.g., growing) multiple layers of graphene on a surface, such as on an adhesive surface, and then breaking the multiple layers off of the surface to produce one or more graphene flakes. The graphene flakes can then be sieved to produce a group of flakes having an average dimension or average major (e.g., largest) dimension. The thickness of the flakes can be controlled by controlling the number of graphene layers disposed on the adhesive surface. For example, graphite having a selected thickness may be disposed on a first adhesive tape. The number of layers of graphene in the graphite may be reduced by adhering subsequent layers of adhesive tape to the graphite on the opposite surface from the first adhesive to remove graphene layers generally one at a time by removing the graphene layers adhered to the subsequent layers of tape. The graphene flake may be removed from the first adhesive tape by striking the first adhesive tape with force sufficient to dislodge the graphene flake(s) from the tape, such as by flicking with a finger or an automated equivalent thereof.

The graphene flakes may have an average flake thickness (measured from first major surface to a second major surface opposite thereto) of at least about 1 μm, such as 1 μm to about 250 μm, about 1 μm to about 100 μm, about 20 μm to about 100 μm, about 40 μm to about 80 μm, about 60 μm to about 100 μm, less than about 200 μm, less than about 100 μm, less than about 80 μm, less than about 60 μm, less than about 40 μm, less than about 20 μm, more than about 10 μm, more than about 20 μm, more than about 30 μm, or more than about 40 μm. As noted above, the graphene flakes may be substantially planar with changes in thickness, folds, peaks, and valleys in the major surfaces thereof. The lateral dimensions of the graphene flakes may be irregular. The average largest major lateral dimension of the graphene flakes may be at least about 20 μm, such as about 20 μm to about 500 μm, about 50 μm to about 300 μm, about 80 μm to about 220 μm, about 100 μm to about 200 μm, at least about 100 μm, at least about 150 μm, at least about 200 μm, less than about 250 μm, or less than about 200 μm.

Due to the valleys and peaks in the graphene flakes formed at least in part from discontinuities in the number of layers across specific regions of a graphene flake, the graphene flakes have been found to remain or float on the surface liquid polymer resins. Such floating results in polymer foams bodies having graphene flakes located only on the outer surface(s) thereof.

The inventor currently believes, the graphene flakes transmit heat throughout the graphene lattice structure of the graphene flake in-plane in the substantially planar structure of the graphene flake and between layers thereof. Accordingly, the graphene flakes retain heat and delay heat release from the polymer foam body to prevent flames from igniting the polymer of the polymer foam body 110 for a longer amount of time than polymer foam bodies without graphene flakes. For example, the heat release foam 100 (or composite laminate structures including the heat release foam 100) disclosed herein exhibits a heat release of less than about 50 kw Min/m² for at least two minutes under United States Federal Aviation Regulation (“FAR”) 25.853 test conditions, less than about 40 kw Min/m² for at least two minutes, less than about 30 kw Min/m² for at least two minutes, less than about 50 kw Min/m² for at least three minutes, less than about 40 kw Min/m² for at least three minutes, less than about 30 kw Min/m² for at least three minutes, less than about 50 kw Min/m² for at least four minutes, less than about 40 kw Min/m² for at least four minutes, or less than about 30 kw Min/m² for at least four minutes (all of the above under FAR 25.853 test conditions). Such heat release values may be accomplished utilizing any of the polymer foams disclosed herein, such as a polyurethane foam.

The majority of the plurality of graphene flakes in a respective layer including graphene flakes (112, 114) may be substantially coplanar with the outer surface of the polymer foam body within the respective layer. The plurality of graphene flakes in a respective layer including graphene flakes may be randomly oriented within the layer.

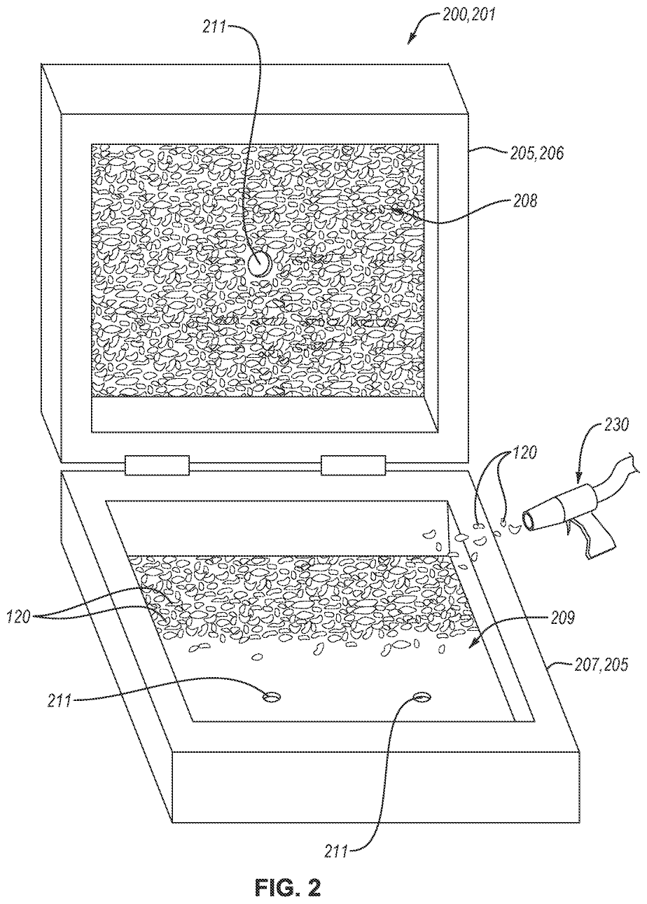

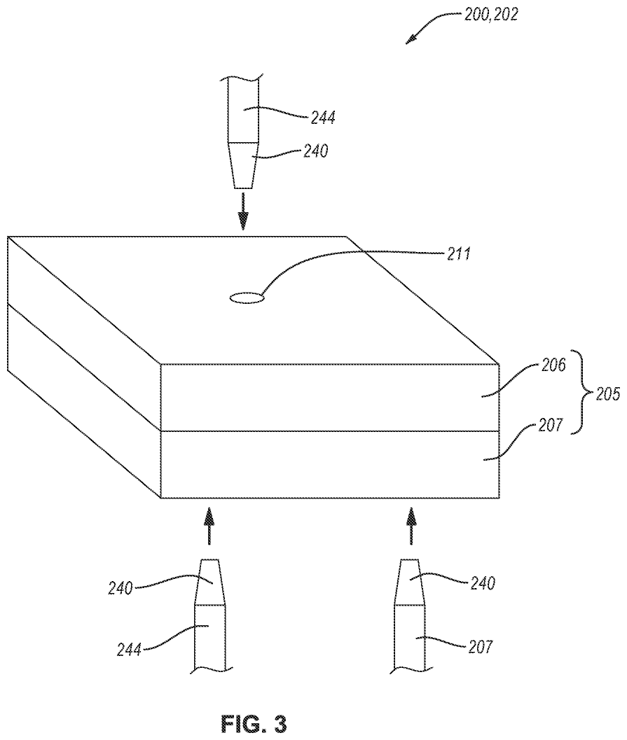

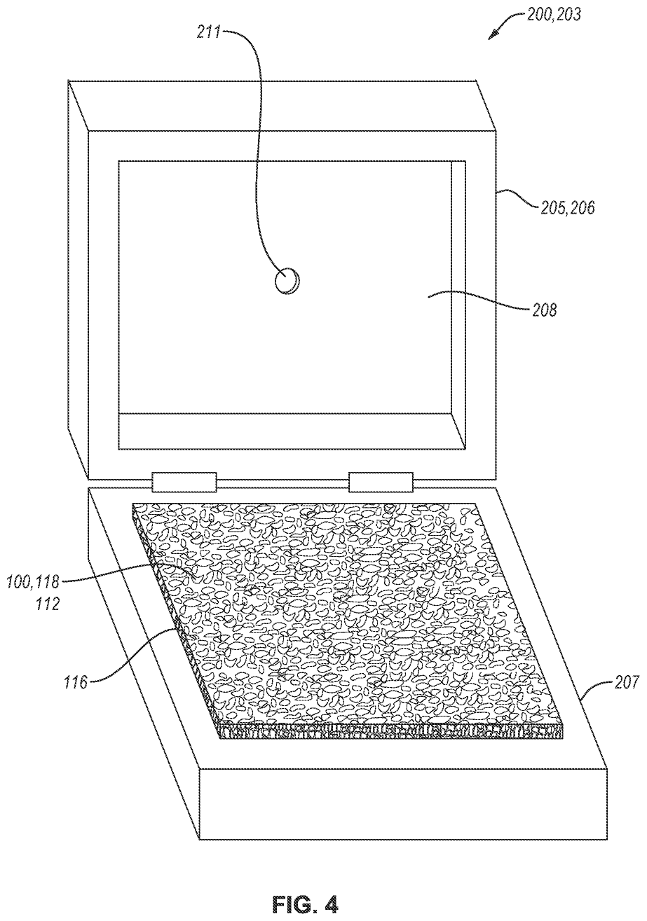

FIGS. 2-4 depict a method 200 of making a heat release foam, according to an embodiment. FIG. 2 depicts block 201 of applying a plurality of graphene flakes onto at least one molding surface of a mold, of the method 200. FIG. 3 depicts block 202 of depositing an uncured polyurethane foam in the mold, of the method 200. FIG. 4 depicts block 203 of curing the polyurethane foam in the mold, of the method 200. The method 200 may include more or fewer blocks than the blocks 201-203. For example, one or more of the blocks 210-230 may be combined with any of the other blocks 210-230 or separated into further blocks.

Referring to FIG. 2, the block 201 of applying a plurality of graphene flakes onto at least one molding surface of a mold includes applying graphene flakes 120 into a mold 205. The mold 205 may include at least a first mold portion 206 (e.g., mold half) and at least a second mold portion 207 (e.g., second mold half). The first mold portion 206 defines the first molding surface 208 and the second mold portion 207 defines the second mold surface 209. The graphene flakes 120 may be applied to one or more of the first molding surface 208 of the second molding surface 209. The mold 205 may include one or more input port 211. For example, the first mold portion 206 may include one or more input ports 211 and the second mold portion 207 may include one or more input ports 211. In some examples, the input port(s) 211 may be sized and shaped to accommodate an input nozzle for injecting the polyurethane foam resin. In some examples (not shown), the one or more input ports 211 may be formed on more than one portion of the mold, such as having half of a sprue on the first mold portion and the other half of the sprue on the second mold portion, such then when the mold is closed, the inlet port 211 is formed at the joint between the mold portions. While shown as mold halves in FIGS. 2-4, in some examples the mold may include more than two pieces. While shown as substantially prismatic, the first and second molding surfaces 208 and 209 may include any shapes, such as contours, channels, or the like. For example, the mold 205 may be sized and shaped to produce any shape and size of a foam body. The mold 205 may be constructed of a material composed to withstand pressure and heat of molding processes, as well as to allow the graphene flakes to at least temporarily adhere thereto. For example, the mold 205 may be constructed of a (e.g., steel, brass, aluminum, etc.), high temperature polymer (e.g., PEI or the like), ceramic, or combinations thereof.

Block 201 of applying a plurality of graphene flakes onto at least one surface of a mold may include spraying graphene flakes onto at least one molding surface of the mold 205. For example, the sprayer 230 may be operably coupled to a supply of graphene flakes and a fluid source to propel the graphene flakes onto the molding surface(s). Any of the graphene flakes disclosed herein may be applied to the mold. In some examples, the fluid from the fluid source may include one or more of compressed gas, a solvent, a propellant, or a liquid. For example, suitable fluids from the fluid source may include compressed air, compressed nitrogen, or a solvent for propelling the graphene flakes 120 from the sprayer 230. Solvents may include water, an alcohol, acetone, or the like. Applying a plurality of graphene flakes onto at least one molding surface of a mold may include spraying the plurality of graphene flakes onto the at least one molding surface in a solvent spray. Applying a plurality of graphene flakes onto at least one molding surface of a mold may include spraying graphene flakes onto all molding surfaces (208, 290) of the mold 205.

In some examples, the graphene flakes 120 may be temporarily adhered to the molding surface(s) via electrostatic interaction, surface tension of the solvent thereon, or an adhesive. The solvent may include one or more components composed to cause the graphene flakes to temporarily adhere to the molding surface(s) 208 and/or 209.

Referring to FIG. 3, the block 202 of depositing an uncured polyurethane foam in the mold may include depositing a polyurethane resin in the mold. For example, a mixture including at least one isocyanate and at least one polyol may be input into the mold 205, such as through the input port(s) 211. Depositing an uncured polyurethane foam in the mold may include injecting the mixture into the mold 205. Upon mixing, the at least one isocyanate (e.g., polyisocyanate) and the at least one polyol in the mixture may form an uncured polyurethane foam. Suitable isocyanates may include one or more of toluene diisocyanate (“TDI”), methylene diphenyl diisocyanate (“MDI”), hexamethylene diisocyanate (“HDI”), methyl isocyanate (“MIC”), naphthalene diisocyanate (“NDI”), isophorone diisocyanate (“IPDI”), or the like. Further isocyanates may be utilized without limitation. Suitable polyols may include at least one of one or more polyether polyols, one or more polyester polyols, or the like. For example, a suitable polyols may include polyethylene oxide, a polyethylene glycol (“PEG”), polypropylene glycol (“PPG”), or mixtures thereof. Further polyols may be utilized without limitation. For example, a polyester polyol may be used to form a PIR foam instead of a polyurethane foam. The isocyanate component(s) may be about 35 wt % to about 65 wt % of the uncured foam mixture, the polyol component(s) may be about 35 wt % to about 65 wt % of the uncured foam mixture.

One or more blowing agents (e.g., acetone, water, carbon dioxide, cyclopentane, isopentane, formic acid, hydrofluorocarbon(s), fluorinated alkenes, methyl formate, etc.), catalysts, colorants, flame retardants, stabilizers (e.g., hydroxybenzotriazole), surfactants (e.g., silicone containing surfactants), or other additives may be input with the components of the uncured polyurethane. For example, an amine catalyst (e.g., triethylenediamine, pentamethyldiethylene triamine, tertiary amine-containing catalysts, quaternary amine salts, or the like) or metal catalysts may be added, such as with the polyol component. The one or more blowing agents, catalysts, colorants, flame retardants, stabilizers, surfactants, or other additives may be, individually or collectively, less than 10 wt % of the uncured polyurethane foam, such as greater than 0 wt % to 3 wt %, 3 wt % to 6 wt %, 6 wt % to 10 wt %, less than 5 wt %, less than 3 wt % or less than 1 wt % of the uncured polyurethane foam (mixture).

As shown, the mold 205 may be filled with the uncured polyurethane foam utilizing one or more injection nozzles 240 fluidly connected to one or more injection lines 244. For example, an injection nozzle 240 may engage with the input ports 211 to fill the cavity of the mold 205 (having the plurality of graphene flakes on the molding surface(s) thereof).

Block 202 may include depositing an alternative uncured polymer in the mold, such as any of the polymers disclosed herein. Block 202 may include depositing one or more additional uncured polymers in the mold, such as a mixture including one or more of any of the uncured polymers disclosed herein. Such polymers or mixtures thereof may form a foam once mixed and input into the mold 205. The mixing may occur in the one or more injection nozzles 240, the one or more injection lines 244, or upstream from the one or more injection lines 244, such as in a fluid storage container fluidly connected to the injection line(s) 244. For example, the components of the foam may be combined to form the polyurethane foam mixture in the injection line 244 or the injection nozzle 240 via separate feed lines fluidly connected thereto. The mixing may occur in the one mold 205, such as by injecting the individual components into the mold 205 separately through different injection nozzles 240.

Referring to FIG. 4, block 203 of curing the polyurethane foam in the mold may include allowing the polyurethane foam to at least partially cure in the mold 205, such as while the mold 205 is closed. Curing the polyurethane foam in the mold may include allowing the polyurethane foam to at least partially cure while the mold 205 is closed and opening the mold to allow the foam to at least partially cure while the mold is open. Curing the polyurethane foam in the mold may include allowing the polyurethane foam to expand to fill the mold. Curing the polyurethane foam in the mold may include controlling a temperature of the mold to a curing temperature, such as below 150° F., below 100° F., below 80° F., above 50° C., about 50° C. to about 150° C., or about 50° C. to about 100° C.

The method 200 may further include removing the at least partially cured polyurethane foam from the mold 205. As shown in FIG. 4, the resulting heat release foam 100 includes the layer including graphene flakes 112 at the first outer surface 118. The plurality of graphene flakes deposited on the molding surface 208 may be adhered to the surface 118 of the polyurethane foam to form the first layer including graphene flakes 112. The intermediate portion 116 is substantially free of graphene flakes. In some examples, the polyurethane foam my be allowed to at least partially cure outside of the mold, such as by one or more of heating, cooling, or letting the foam rest for a duration outside of the mold. In some examples, a sprue may be present on the first outer surface 118 where the input port 211 is located. The sprue may be removed after opening the mold 205.

The resulting heat release foam 100 may include a structural foam (e.g., rigid foam), an upholstery foam (e.g., relatively soft, resilient foam), or any other foam. The heat release foam 100 may be formed as or into a monolithic part. For example, the heat release foam 100 may be compressed in a mold (e.g., the same mold as used during formation of the foam or a separate mold) to form a monolithic structure. The heat release foam 100 may be included in a composite laminate (e.g., sandwich) structure.

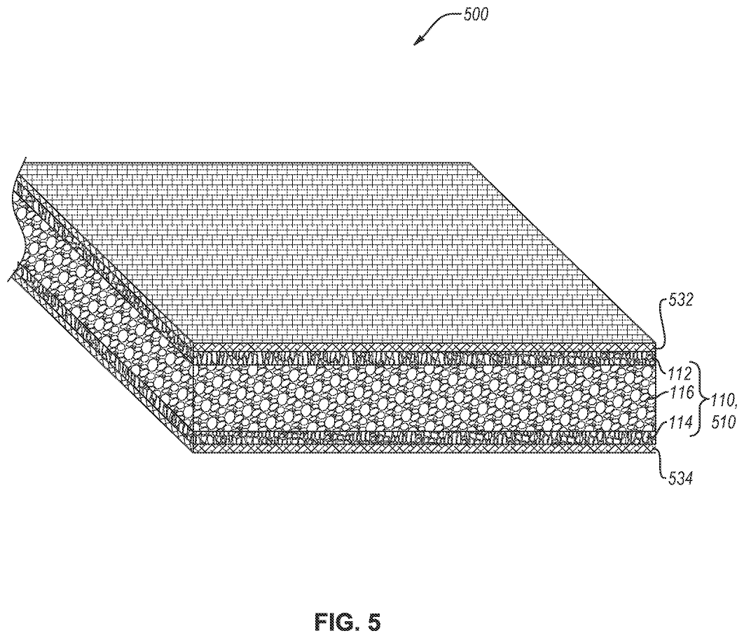

FIG. 5 is an isometric view of a composite laminate structure 500, according to an embodiment. The composite laminate structure 500 includes a core 510, a first fiber layer 532, and optionally, a second fiber layer 534. The first fiber layer 532 may be disposed on a first outer surface of the core 510 and the second fiber layer 534 may be disposed on the second outer surface of the core 510, substantially opposite the first fiber layer 532. The core 510 may include the heat release foam 100 (FIG. 1). For example, the core 510 may include the polymer foam body 110, the first layer including graphene flakes 112, the intermediate portion 116, and optionally, the second layer including graphene flakes 114.

The polymer foam body 110 defines one or more outer surfaces (118, 119 of FIG. 1) disposed around intermediate portion 116, wherein the one or more layers including graphene flakes (112 and 114) are located on at least one of the one or more outer surfaces of the polymer foam body 110, wherein the intermediate portion 116 is substantially free of graphene flakes (120 of FIG. 1). In embodiments with only one layer including graphene flakes, the layer including graphene flakes may be located on a surface of the core 510 of the composite laminate structure intended to be an outward facing surface. The core 510 may be substantially planar. The core 510 may have one or more shapes, contours, folds, or other structures therein. For example, the core 510 may be premolded with one or more contours, shapes, folds, etc. therein. Such examples, may aid in creating molded composite laminates with crisp details that fill the mold without trapping air in the mold and having imperfections therefrom. The outer surfaces of the core 510 may include at least an upper surface and a lower surface. One or more of the upper surface or the lower surface may include the layer(s) including graphene flakes. The polymer foam body 110 may include a polyurethane foam or any of the other polymer foams disclosed herein.

The first fiber layer 532 includes a first plurality of fibers and a first polymer resin. The first plurality of fibers may include glass fibers, aramid fibers, polymer fibers (e.g., thermoset fibers or thermoplastic fibers), carbon fibers, or the like. The first plurality of fibers may include a mat, sheet, or fabric of fibers, such as randomly oriented fibers, woven fibers, biaxially oriented fibers, or the like. The thermoset or thermoplastic fibers may include any of the thermoplastic or thermosets disclosed below. The first plurality of fibers includes the first polymer resin at least partially distributed therein.

The first polymer resin may include a thermoset resin, a thermoplastic resin, or mixtures thereof. The thermoset resin may include one or more thermoset polymers, such as one or more epoxies, one or more polyurethanes, phenolic resin, benzoxazines, or the like. The thermoplastic resin may include one or more thermoplastic polymers, such as polyetherimide (“PEI”), polypropylene, a polycarbonate, polyethylene, polyphenylene sulfide, polyether ether ketone (“PEEK”) or another polyaryletherketone, an acrylic, or the like. Suitable polymer resins, including thermoplastic polymers and/or thermoset polymers, are disclosed in International Patent Application No. PCT/US2015/034051, filed on 3 Jun. 2015, the disclosure of which is incorporated herein, in its entirety, by this reference.

The first fiber layer 532 may be bonded to the core 510 by the first polymer resin, or one or more intermediate layers disposed therebetween. For example, the first polymer resin may at least partially infiltrate into the polymer foam core, thereby bonding the first fiber layer 532 to the core 510. The first polymer resin may form a microfoam when applied, heated, or mixed. For example, a component of the first polymer resin (e.g., epoxy) may form a microfoam foam when mixed with one or more additional components (e.g., water or polyurethane). The microfoam may aid in bonding to the core 510. For example, the microfoam may infiltrate into the core 510 and bond the core to the first fiber layer upon curing. The first fiber layer 532 may be an outer surface of the composite laminate structure and the layer including graphene flakes (of the core 510) is disposed against the first fiber layer 532.

The second fiber layer 534 includes a second plurality of fibers and a second polymer resin at least partially dispersed therein. The second plurality of fibers in the second fiber layer 534 may be similar or identical to the first plurality of fibers disclosed herein for the first fiber layer 532, including one or more of fiber type and layer type (e.g., woven fabric or randomly oriented mat). The second polymer resin may be similar or identical to any of the polymer resins disclosed herein for the first polymer resin.

In some examples, the second plurality of fibers may be the same as the first plurality of fibers in one or more aspects. In some examples, the second plurality of fibers may differ from the first plurality of fibers in one or more aspects. For example, the second plurality of fibers may include glass fibers and the first plurality of fibers may include carbon fibers. The second polymer resin may be identical to the first polymer resin. In some examples, the second polymer resin may differ from the first polymer resin in one or more aspects. For example, the first polymer resin may include a first thermoset resin (e.g., epoxy-polyurethane mixture) and the second polymer resin may include a second thermoset resin (e.g., polyurethane) or a thermoplastic resin (e.g., PEI). In some examples, the first polymer resin may include a PEI resin and the second polymer resin my include an epoxy-polyurethane resin. The polymer resins disclosed herein may include one or more of fillers, catalysts, blowing agents, hardeners, or a foam controlling agent.

By locating the portion of the composite laminate structure 500 having the layer including graphene flakes in an outward direction, the composite laminate structure may have relatively low heat release (e.g., exhibit a heat release of less than 50 kw Min/m² for at least two minutes under FAR 25.853 test conditions) compared to an identical composite laminate without the layer(s) including graphene flakes. By utilizing graphene flakes on both major surfaces of the core, the resulting composite laminate structure may have low heat release when exposed to ignition sources from either side. Further, by keeping the intermediate portion of the core substantially graphene flake-free, the extremely high costs of utilizing graphene flakes throughout the entire foam body 110 of the core 510 may be avoided. Additionally, by utilizing the polymer resins and fibers disclosed herein, relatively low fire, smoke, and toxicity values may also be achieved for the composite laminate structures disclosed herein.

Additional layers may be utilized in the composite laminate structure 500, such as additional fiber layers, polymer layers, additional cores, or the like. For example, the composite laminate 500 may include at least one additional fiber layer disposed over one or more of the first fiber layer 532 or the second fiber layer 534. The additional fiber layers may be similar or identical to any of the fiber layers disclosed herein. In some examples, additional layers may be disposed between one or both of the first fiber layer 532 and the core 510 or the second fiber layer 534 and the core 510. For example, at least one additional fiber layer may be disposed between one or more of the first fiber layer 532 and the core 510 or the second fiber layer 534 and the core 510. The at least one additional layer may be a purely polymer layer, such as a thermoset layer or a thermoplastic layer. The purely polymer layer(s) may include a flame retardant or resistant resin, such as a phenolic resin, PEI, or the like.

Any of the layers of the composite laminate structure 500, including the additional layers, may include graphene flakes disposed thereon, such as on an outwardly facing or inwardly facing surface thereof. For example, one or more of the first fiber layer 532 or the second fiber layer 534 may include graphene particles on an outwardly facing surface thereof. In such examples, the heat release of the resulting composite laminate structure is expected to be even lower than composite laminate structures only having graphene flakes in the foam core with layers including graphene flakes.

The polymer resins in the fiber layer(s) may be cured to provide a substantially rigid composite laminate structure. For example, the polymer resins in the first and second layers may be cured to form a rigid composite laminate structure having the heat release controlled core therebetween.

The composite laminate structure 500 may be molded to form a component of an article, such as an automobile (e.g., hood, door, fender, roof, etc.), aerospace (e.g., plane seatback, overhead bins, bulkheads, etc.), marine (e.g., moldings, doors, etc.), rail (e.g., doors, seats, baggage bins, bulkheads, etc.), or the like.

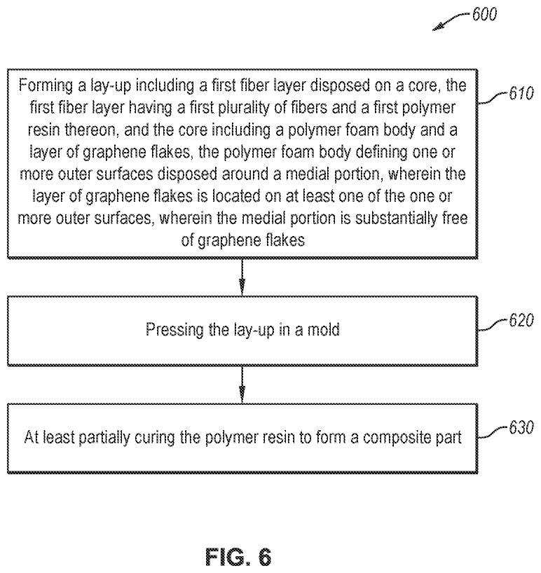

Composite laminate parts may be made by molding. FIG. 6 is a flow diagram of a method 600 for making a heat release controlled composite structure, according to an embodiment. The method 600 includes the block 610 of forming a lay-up including a first fiber layer disposed on a core, the first fiber layer having a first plurality of fibers and a polymer resin thereon, and the core including a polymer foam body and a layer including graphene flakes, the polymer foam body defining one or more outer surfaces disposed around an intermediate portion, wherein the layer including graphene flakes is located on at least one of the one or more outer surfaces, wherein the intermediate portion is substantially free of graphene flakes; the block 620 of pressing the lay-up in a mold; and the block 630 of at least partially curing the polymer resin to form a composite part. In some examples, the method 600 may include more or fewer blocks than the blocks 610-630. For example, blocks 620 and 630 may be combined into a single block.

Block 610 of forming a lay-up including a first fiber layer disposed on a core, the first fiber layer having a first plurality of fibers and a polymer resin thereon, and the core including a polymer foam body and a layer including graphene flakes, the polymer foam body defining one or more outer surfaces disposed around an intermediate portion, wherein the layer including graphene flakes is located on at least one of the one or more outer surfaces, wherein the intermediate portion is substantially free of graphene flakes may include forming the lay-up outside of the mold or inside of the mold. Forming the lay-up may include positioning at least some of the components of the composite laminate structure on top of each other. In a simple example, forming the lay-up may include placing a core on a second fiber layer and then placing the first fiber layer on the core. The core of the lay-up may include any of the cores or polymer foam bodies disclosed herein. For example, the core includes a polymer foam body with at least one layer including graphene flakes disposed on at least one outer surface of the foam body and the polymer foam body includes an intermediate portion that is substantially free of graphene flakes between the outer surfaces (or at least one layer(s) including graphene flakes).

The fiber layer(s) of the lay-up may include any of the fiber layers disclosed herein. For example, the first fiber layer may include a first plurality of fibers and a first polymer resin thereon. The first plurality of fibers may include any of the pluralities of fibers disclosed herein. The first polymer resin may include any of the polymer resins disclosed herein. The first fiber layer may be provided as a layer of fibers pre-impregnated with a polymer resin (“pre-preg”). In some examples, the first fiber layer may be provided as a dry fiber sheet and a polymer resin may be applied thereto, such as by spraying or brushing the polymer resin onto the fiber sheet. At least a second fiber layer may be provided as a pre-preg or a dry fiber sheet with a polymer resin later applied thereto.

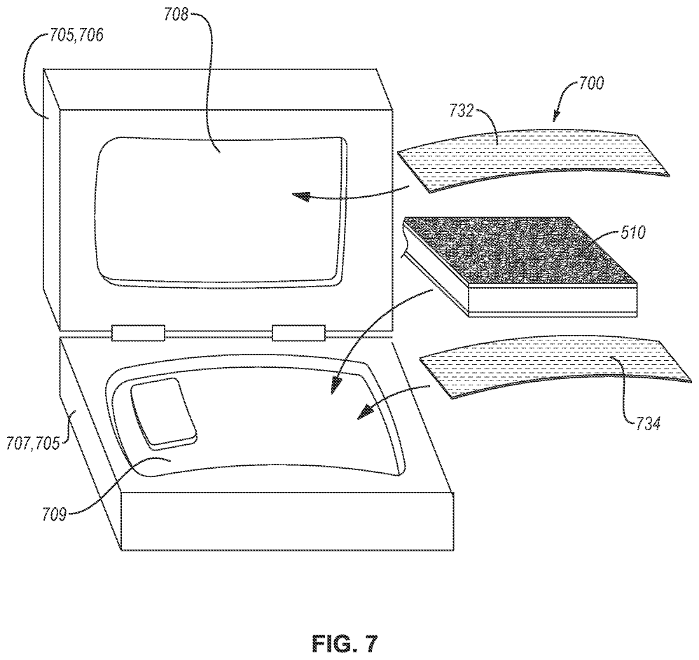

FIG. 7 is an isometric view of a lay-up 700 being placed into a mold 705, according to an embodiment. The lay-up includes the core 510, the first fiber layer 732, and optionally, the second fiber layer 734. The first fiber layer 732 may be similar or identical to any of the fiber layers disclosed herein, in one or more aspects, such as the first fiber layer 532 (FIG. 5). For example, the first fiber layer 732 may include a first plurality of fibers and a first polymer resin. The second fiber layer 734 may be similar or identical to any of the fiber layers disclosed herein, in one or more aspects, such as the second fiber layer 534 (FIG. 5). For example, the second fiber layer 734 may include a second plurality of fibers and a second polymer resin. The first plurality of fibers and/or the second plurality of fibers may include any of the fibers disclosed herein, such as carbon, aramid, glass, thermoset, or thermoplastic fibers. the first polymer resin and the second polymer resin may include any of the polymer resins disclosed herein.

The polymer resin(s) of the fiber layer(s) 732 and/or 734 may be uncured in the lay-up 700. For example, the first polymer resin may be applied to the first plurality of fibers via a sprayer, brush, or roller, and the second polymer resin (if present) may be applied similarly to the second plurality of fibers (if present). In some examples, the polymer resin of a respective layer of fibers may be sprayed onto the layer of fibers after the layer of fibers are placed into the mold 705. The core 510 may be positioned on the fiber layer or between the fiber layers. The mold 705 may be closed and compressed to form the composite laminate part.

As shown, forming the lay-up 700 may include placing the first fiber layer 732 into the mold 705, such as onto the first molding surface 708 in the first mold half 706. The first polymer resin may be disposed on the first fiber layer 732 prior to or after the first fiber layer 732 is disposed in the mold 705. The core 510 may be placed on the first fiber layer 732. In some examples, forming a lay-up may include placing the first plurality of fibers and the first polymer resin onto the core.

In some example, the lay-up 700 includes the second fiber layer 734. For example, the lay-up 700 may include at least the second fiber layer 734 disposed on an opposite side of the core 510 from the first fiber layer 732. In such examples, forming the lay-up may include placing the second plurality of fibers onto the core and placing the second polymer resin onto the second plurality of fibers. The second fiber layer 734 may be placed on the core 510 on the opposite side thereof from the first fiber layer 732 or may be disposed in the mold in second mold half 707, such as on the second molding surface 709. The second polymer resin may be disposed on the second fiber layer 734 prior to or after the second fiber layer 734 is disposed in the mold 705. Of course, the mold may include more than two portions in some examples.

Forming a lay-up including a first fiber layer disposed on a core may include forming the lay-up in the mold. For example, the first fiber layer 732 may be applied to the first molding surface 708 or the core 510 in the mold 705. Likewise, forming the lay-up in the mold may include applying the second fiber layer 734 to the core 510 on an opposite side thereof from the first fiber layer 732 or may include applying the second fiber layer 734 to the second molding surface 709.

Forming the lay-up may include placing one or more of the components of the lay-up 700 in contact with each other. Such formation may be accomplished by directly stacking one or more of the components on each other. Forming the lay-up may include placing the components of the lay-up 700 into the mold in positions therein, such that when the mold is closed, the components are stacked in the selected order.

Forming the lay-up may include disposing graphene flakes on one or more components of the lay-up or on one or more molding surfaces of the mold. For example, forming the lay-up may include spraying graphene flakes onto one or more of the first fiber layer 732, the second fiber layer 734, or at least one molding surface, such as in a solvent as disclosed herein for the formation of the heat release foam. By spraying the graphene flakes on the molding surface(s) and then placing the fiber layer(s) containing a polymer resin on the graphene flake-coated surface(s), the resulting fiber layers in the composite laminate additionally include graphene flakes on at least the outer surface thereof. Additionally or alternatively, forming the lay-up may include disposing the graphene flakes on inwardly facing surfaces of the fiber layer(s), such as by spraying the graphene flakes on the inwardly facing surface(s) of the fiber layer(s). The resulting composite laminate may exhibit lower heat release values than composite laminate structures having fiber layers without the graphene flakes.

Returning to FIG. 6, block 620 of pressing the lay-up in a mold may include closing the lay-up in the mold. Pressing the lay-up in a mold may include applying compressive force thereto, such as at least about 1 kPa, about 1 kPa to 1 MPa, 1 MPa to 1 GPa, less than 1 GPa, or less than 100 MPa. Pressing the lay-up in the mold may include holding the pressure on the mold for a selected duration, such as at least one second, about one second to about one hour, about three seconds to about one minute, about one minute to about five minutes, about five minutes to about 10 minutes, less than one hour, less than 10 minutes, or more than 30 seconds.

Block 630 of at least partially curing the first polymer resin may include at least partially curing at least the first polymer resin (e.g., with any other polymer resins) in the lay-up. For example, at least partially curing the first polymer resin may include at least partially curing at least the second polymer resin. As the polymer resin(s) cure, the lay-up sets in a shape to provide an at least semi-rigid composite laminate structure. At least partially curing the first polymer resin to form a composite part may include at least partially curing the first polymer resin inside of the mold, outside of the mold, or both. For example, at least partially curing the first polymer resin may include partially curing at least the first polymer resin in the mold, removing the partially cured composite laminate from the mold, and finishing curing at least the first polymer resin outside of the mold, such as on a cooling surface.

At least partially curing the first polymer resin to form a composite part may include heating the mold to a selected temperature for a selected duration, such as while pressing the lay-up in the mold. The selected duration may be at least about five seconds, such as about five seconds to about one hour, about 10 seconds to about five minutes, about five minutes to about 10 minutes, about 10 minutes to about one hour, less than about one hour, less than about 30 minutes, more than about 1 minute, more than about 5 minutes, more than about 30 minutes, or more than about one hour. The selected temperature may be at least about 50° F., such as about 50° F. to about 300° F., about 50° F. to about 100° F., about 100° F. to about 150° F., about 150° F. to about 200° F., about 200° F. to about 300° F., less than about 300° F., less than about 200° F., or less than about 100° F.

The method 600 may include forming the foam core, such as via any of the methods of forming a heat release foam disclosed herein. The method 600 may include removing the formed composite part (e.g., composite laminate structure) from the mold. Such removal may occur during or after curing the polymer resin(s).

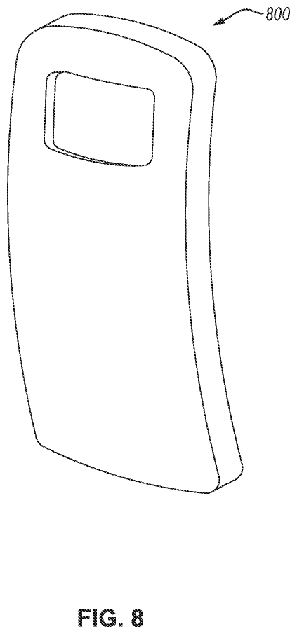

The composite laminate parts or structures disclosed herein and/or formed by the method 600 may include one or more components of an automobile (e.g., hood, doors, roof, fenders, etc.), an aircraft (e.g., plane seat, baggage bin, bulkhead, etc.), a boat (e.g., bulkhead, seat, molding, storage bins, etc.), or train car (e.g., bulkhead, seat, molding, storage bins, etc.), such as any of the parts of types thereof disclosed herein. FIG. 8 shows a seatback 800 formed from the lay-up in the mold of FIG. 7. As shown, the seatback 800 may be removed from the mold 705 of FIG. 7. The shape of the seatback 800 conforms to the molding surfaces 708 and 709. The layer including graphene flakes may face outward in the seatback 800. Accordingly, the surface that faces a passenger sitting behind the seat may exhibit a relatively low heat release (e.g., any of the heat release values disclosed herein). Additionally, the seatback may exhibit a relatively low FST score (qualifying as safe under US or international aviation administration standards). The core having the graphene flakes may allow the seatback to be relatively inexpensive compared to a core that has graphene particles dispersed therethrough.

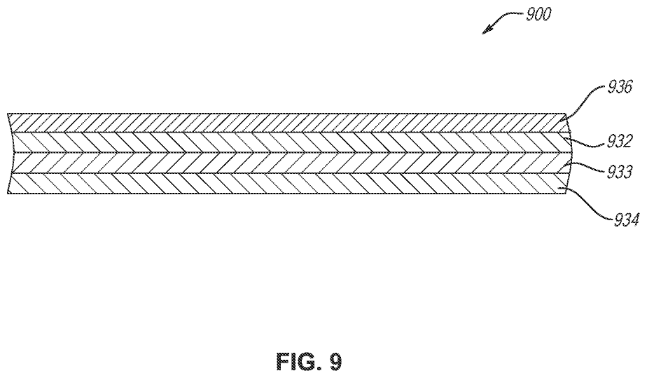

In some examples, graphene flakes may be utilized in monolithic or laminate components without foam or in layers separate from the foam. FIG. 9 is a cross-sectional view of a composite laminate 900, according to an embodiment. The composite laminate 900 includes a plurality of fiber layers including the first fiber layer 932, the second fiber layer 934, and optionally, at least one additional fiber layer 933 disposed between the first fiber layer 932 and the second fiber layer 934. Any number of additional fiber layers may be disposed between the first fiber layer 932 and the second fiber layer 934. The composite laminate 900 includes an outer polymer layer 936 disposed on the first fiber layer 932. While depicted as having four layers, more or fewer layers may be included in some examples.

The first fiber layer 932 may be similar or identical to any of the fiber layers disclosed herein, in one or more aspects, such as the first fiber layer 532 (FIG. 5). For example, the first fiber layer 932 may include a first plurality of fibers and a first polymer resin. The second fiber layer 934 may be similar or identical to any of the fiber layers disclosed herein, in one or more aspects, such as the second fiber layer 534 (FIG. 5). For example, the second fiber layer 934 may include a second plurality of fibers and a second polymer resin. The optional at least one additional layer 933 may be similar or identical to any of the fiber layers disclosed herein, such as including an additional plurality of fibers disposed in an additional polymer resin. The first plurality of fibers, the second plurality of fibers, and/or the at least one additional plurality of fibers may include any of the fibers disclosed herein, such as carbon, aramid, glass, thermoset, or thermoplastic fibers. One or more of the type, thickness, density, or form of fibers may differ between the respective fiber layers of the composite laminate 900. The density of the plurality of fibers in a respective fiber layer may include any of the densities disclosed herein (e.g., 50 gsm to 300 gsm).

The first polymer resin, the second polymer resin, and the at least one additional polymer resin may include any of the polymer resins disclosed herein, such as an a thermoset resin (e.g., epoxy, polyurethane, epoxy-polyurethane mixture, etc.), a thermoplastic resin (e.g., polyetherimide, polyether ether ketone, etc.), or mixtures thereof. The density of the respective fiber layers may include any of the densities disclosed herein (e.g., 50 gsm to 300 gsm). The amount of polymer resin in the respective fiber layers may vary between fiber layers or may be substantially uniform between the fiber layers. For example, an individual fiber layer may include at least 1 wt % polymer resin (e.g., at least 10 grams), such as 1 wt % to 80 wt %, 1 wt % to 10 wt %, 10 wt % to 30 wt %, 30 wt % to 60 wt %, or 50 wt % to 80 wt % polymer resin. The remainder of each individual fiber layer may include the plurality of fibers therein. The thickness (after pressing and curing) of the fibers layers may vary, such as each layer being at least 1 mm thick, 1 mm to 10 mm, 1 mm to 3 mm, 3 mm to 6 mm, 6 mm to 10 mm, less than 10 mm, less than 3 mm, or less than 1 mm thick.

The outer polymer layer 936 may be disposed on the first fiber layer 932. The outer polymer layer 936 may include an outer polymer resin and graphene flakes. The outer polymer resin in the outer polymer layer 936 may include any of the polymer resins disclosed herein. The outer polymer resin may include graphene flakes therein, such as any of the graphene flakes disclosed herein. The graphene flakes may be at least 2 wt % of the outer polymer layer 936, such as 2 wt % to 50 wt %, 2 wt % to 10 wt %, 5 wt % to 15 wt %, 10 wt % to 20 wt %, less than 20 wt %, or less than 10 wt % of the outer polymer layer 936. The graphene flakes may be disposed on an outer surface of the outer polymer layer 936. For example, the graphene flakes may float on the surface of the outer polymer resin of the outer polymer layer 936 during manufacturing. The graphene flakes may be applied to the mold surface prior to applying the outer polymer resin thereto to form the outer polymer layer 936. Accordingly, the outer polymer layer 936 may include graphene flakes on the outer surface or outer region (e.g., outermost 50%, 30%, 20%, or 10% volume of the layer) thereof, with the remainder (e.g., innermost volume) of the outer polymer layer 936 being substantially free of graphene flakes. In some examples, the thickness of the outer polymer layer 936 may be sufficiently small (e.g., 1 mm to 3 mm) to allow the graphene flakes to be dispersed therethrough. In any case, the outer polymer layer provides an outer layer of graphene flakes disposed over the fiber layers thereunder.

As shown in FIG. 9, the outermost layer (e.g., outward facing surface) of the composite laminate 900 includes the graphene flakes therein. By locating the graphene flakes on the outer polymer layer 936, the resulting composite laminate 900 provides excellent heat release properties (e.g., a heat release of less than 50 kw Min/m² for at least two minutes under FAR 25.853 test conditions).

In an example of the composite laminate 900, the outer polymer layer 936 includes 94 wt % polymer resin and 6 wt % graphene flakes, the first fiber layer 932 includes an 80 gsm NCF glass fiber sheet with 32 grams of polymer resin therein, the second fiber layer 934 includes an 80 gsm NCF glass fiber sheet with 32 grams of polymer resin therein, the at least one additional fiber layer 933 includes an 80 gsm NCF glass fiber sheet with 32 grams of resin therein. While described as being a laminate, a foam core may be disposed between any of the layers of the composite laminate 900 to form a composite sandwich structure having graphene flakes in the outer polymer layer and the foam core.

The composite laminate 900 may be formed from a lay-up having uncured components therein. The lay-up may be compressed and cured to form the composite laminate 900, such as in a mold as disclosed herein with respect to the method 600.

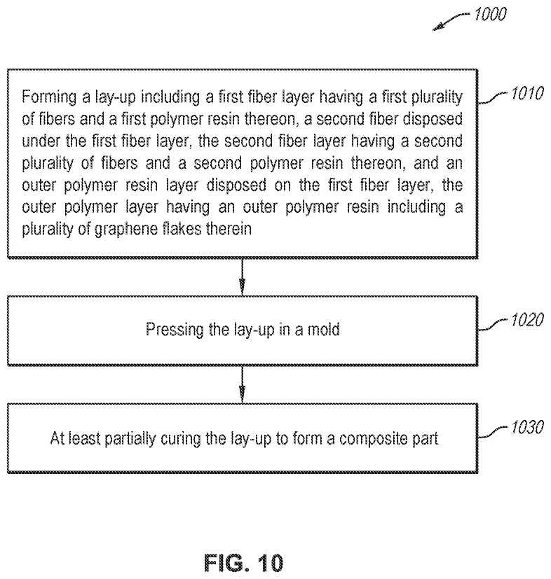

FIG. 10 is a flow diagram of a method 1000 for making a heat release controlled composite structure, according to an embodiment. The method 1000 includes the block 1010 of forming a lay-up including a first fiber layer having a first plurality of fibers and a first polymer resin thereon, a second fiber disposed under the first fiber layer, the second fiber layer having a second plurality of fibers and a second polymer resin thereon, and an outer polymer layer disposed on the first fiber layer, the outer polymer layer having an outer polymer resin including a plurality of graphene flakes therein; the block 1020 of pressing the lay-up in a mold; and the block 1030 of at least partially curing the lay-up to form a composite part. In some examples, the method 1000 may include more or fewer blocks than the blocks 1010-1030. For example, blocks 1020 and 1030 may be combined into a single block.

Block 1010 of forming a lay-up including a first fiber layer having a first plurality of fibers and a first polymer resin thereon, a second fiber disposed under the first fiber layer, the second fiber layer having a second plurality of fibers and a second polymer resin thereon, and an outer polymer layer disposed on the first fiber layer, the outer polymer layer having an outer polymer resin including a plurality of graphene flakes therein may include forming the lay-up outside of the mold, inside of the mold, or portions of both. Forming the lay-up may include positioning at least some of the uncured components of the composite laminate on top of each other. In a simple example, forming the lay-up may include positioning the components of first fiber layer (e.g., first plurality of fibers and the first polymer resin) on the components of the second fiber layer and then positioning the components of the outer polymer layer (e.g., outer polymer resin) having a plurality of graphene flakes therein on the first fiber layer.

The fiber layer(s) of the lay-up may include any of the fiber layers disclosed herein. For example, the first fiber layer may include a first plurality of fibers and a first polymer resin thereon. The first plurality of fibers may include any of the pluralities of fibers disclosed herein. The first polymer resin may include any of the polymer resins disclosed herein. The first fiber layer may be provided as a pre-preg. In some examples, the first fiber layer may be provided as a dry fiber sheet and a polymer resin may be applied thereto, such as by spraying or brushing the first polymer resin onto the first fiber sheet. The second fiber layer may include a second plurality of fibers and a second polymer resin thereon. The second plurality of fibers may include any of the pluralities of fibers disclosed herein. The second polymer resin may include any of the polymer resins disclosed herein. For example, the second fiber layer may be provided as a pre-preg or a dry fiber sheet with a polymer resin later applied thereto.

Forming the lay-up may include positioning (the components of) at least one additional fiber layer between the (components of the) first fiber layer and the (components of the) second fiber layer, such as one additional fiber layer, two additional fiber layers, three additional fiber layers, four additional fiber layers, or five additional fiber layers. Each additional fiber layer may include an additional plurality of fibers and an additional polymer resin thereon. The additional plurality of fibers may include any of the pluralities of fibers disclosed herein. The additional polymer resin may include any of the polymer resins disclosed herein.

The polymer resin(s) may be disposed on the respective fiber layers prior to or after disposing the respective fiber layer(s) in the mold. The polymer resin(s) of the respective fiber layer(s) may be uncured in the lay-up. For example, the first polymer resin may be applied to the first plurality of fibers via a sprayer, brush, or roller; the second polymer resin may be applied similarly to the second plurality of fibers; and the additional polymer resin (if present) may be applied similarly to the additional plurality of fibers (if present). For example, the polymer resin of a respective layer of fibers may be sprayed onto the layer of fibers after the layer of fibers are placed into the mold.

Forming the lay-up may include placing the second plurality of fibers onto the mold surface and placing the second polymer resin onto the second plurality of fibers. The first fiber layer may be disposed on the second fiber layer. For example, forming a lay-up may include placing the first plurality of fibers and the first polymer resin onto the second fiber layer. Forming the lay-up may include forming the lay-up in the mold may include applying the first fiber layer on the second fiber layer (or at least one additional fiber layer, when present).

Forming the lay-up may include disposing the (components of the) outer polymer layer on the first fiber layer in the mold or out of the mold. For example, disposing the outer polymer layer on the first fiber layer may include forming the outer polymer resin. In such examples, the outer polymer layer includes a polymer resin with graphene flakes therein. The graphene flakes may be disposed on a molding surface opposite the first fiber layer in the mold, such as via spraying in a fluid stream. The fluid stream may include a gas or a solvent. The solvent may serve to temporarily retain the graphene flakes against the molding surface via surface tension. In some examples, electrostatic interaction may be utilized to retain the graphene flakes on the mold surface, such as by electrostatically charging the molding surface prior to applying the graphene flakes thereto. An outer polymer resin may be applied onto the molding surface over the graphene flakes to form the uncured outer polymer layer (e.g., outer polymer resin with graphene flakes therein). Alternatively or additionally, the outer polymer resin may be applied onto the first fiber layer after which the mold may be closed to bring the graphene flakes into contact with the outer polymer resin (on the lay-up disposed on an opposite mold half) to form the uncured outer polymer layer. The outer polymer resin may include any of the polymer resins disclosed herein.

In some examples, the graphene flakes may be applied directly onto an outer surface of the uncured polymer resin of the outer polymer layer. In such examples, the resin of the outer polymer layer may be applied onto the first fiber layer, such as via spraying, painting, pouring, brushing, or the like, and the graphene flakes may be sprayed thereon. The graphene flakes may be sprayed onto the uncured resin of the outer polymer layer (that is disposed over the first fiber layer) at a selected rate (e.g., in a gaseous stream) to control the amount of graphene flakes in the outer polymer layer. In such examples, the graphene flakes may be limited to the outer surface of the outer polymer layer or an outermost portion (e.g., volume) thereof, such as the outer half, outer third, or outer quarter of the outer polymer layer.

In some examples, the graphene flakes may be mixed with the outer polymer resin of the outer polymer layer prior to application in the lay-up. For example, a polymer resin with graphene flakes therein may be applied onto the first fiber layer to form the outer polymer layer.

Forming the lay-up may include placing one or more of the components of the lay-up in contact with each other. Such formation may be accomplished by directly stacking one or more of the components on each other. Forming the lay-up may include placing the components of the lay-up into the mold in positions therein, such that when the mold is closed, the components are stacked in the selected order. For example, forming the lay-up may include disposing graphene flakes on one or more components of the lay-up or on one or more molding surfaces of the mold.

Returning to FIG. 10, block 1020 of pressing the lay-up in a mold may include closing the lay-up in the mold. Pressing the lay-up in a mold may include applying compressive force thereto, such as at least about 1 kPa, about 1 kPa to 1 MPa, 1 MPa to 1 GPa, less than 1 GPa, or less than 100 MPa. Pressing the lay-up in the mold may include holding the pressure on the mold for a selected duration, such as at least one second, about one second to about one hour, about three seconds to about one minute, about one minute to about five minutes, about five minutes to about 10 minutes, less than one hour, less than 10 minutes, or more than 30 seconds.

Block 1030 of at least partially curing the lay-up may include at least partially curing at least the first polymer resin, and the second polymer resin, and the outer polymer resin (e.g., with any other polymer resins) in the lay-up. As the polymer resin(s) cure, the lay-up sets in a shape to provide an at least semi-rigid composite laminate structure. At least partially curing the lay-up to form a composite part may include at least partially curing the polymer resin(s) inside of the mold, outside of the mold, or both. For example, at least partially curing the polymer resins in the lay-up may include partially curing at least the polymer resins in the mold, removing the partially cured composite laminate from the mold, and finishing curing at least the polymer resins outside of the mold, such as on a cooling surface.

At least partially curing the lay-up to form a composite part may include heating the mold to a selected temperature for a selected duration, such as while pressing the lay-up in the mold. The selected duration may be at least about five seconds, such as about five seconds to about one hour, about 10 seconds to about five minutes, about five minutes to about 10 minutes, about 10 minutes to about one hour, less than about one hour, less than about 30 minutes, more than about 1 minute, more than about 5 minutes, more than about 30 minutes, or more than about one hour. The selected temperature may be at least about 50° F., such as about 50° F. to about 300° F., about 50° F. to about 100° F., about 100° F. to about 150° F., about 150° F. to about 200° F., about 200° F. to about 300° F., less than about 300° F., less than about 200° F., or less than about 100° F.

The method 1000 may include removing the formed composite part (e.g., composite laminate structure) from the mold. Such removal may occur during or after curing the polymer resin(s).

The composite laminate parts or structures disclosed herein and/or formed by the method 1000 may include one or more components of an automobile (e.g., hood, doors, roof, fenders, etc.), an aircraft (e.g., plane seat, baggage bin, bulkhead, etc.), a boat (e.g., bulkhead, seat, molding, storage bins, etc.), or train car (e.g., bulkhead, seat, molding, storage bins, etc.), such as any of the parts of types thereof disclosed herein.

### WORKING EXAMPLE

Working Example A of heat release foam part was formed as an MDI-based polyurethane foam. Graphene flakes in water were sprayed into a molding surfaces of a mold. The graphene flakes adhered to the molding surfaces via surface tension. The mold was closed and polyurethane foam forming components were injected into the mold via ports. The polyurethane foam forming components were allowed to react and expand to form the polyurethane foam. The graphene flakes adhered to the foam at the molding surfaces. The mold was opened and the polyurethane foam was allowed to cool to form Working Example A. Working example A was cut in cross-section to expose the interior of the polymer foam body.

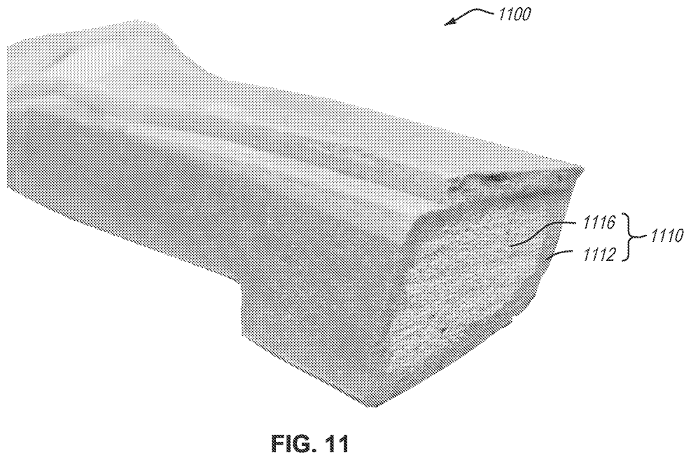

FIG. 11 is a photo of a heat release foam part 1100 of working example A. The heat release foam part 1100 of Working Example A includes the polyurethane foam body 1110 having an intermediate portion 1116 and a layer including graphene flakes 1112 surrounding the intermediate portion 1116. The layer including graphene flakes 1112 includes graphene flakes penetrated into the foam body 1110 a minimal distance from the outer surfaces thereof. As shown, the layer including graphene flakes 1112 does not have a perfectly uniform thickness but has a substantially consistent average thickness from the outer surface. As also shown, the intermediate portion 1116 is visibly lighter than the layer including graphene flakes 1112, which is due to the intermediate portion 1116 being substantially free of the graphene flakes.

As used herein, the term “about” or “substantially” refers to an allowable variance of the term modified by “about” by ±10% or ±5%. Further, the terms “less than,” “or less,” “greater than”, “more than,” or “or more” include as an endpoint, the value that is modified by the terms “less than,” “or less,” “greater than,” “more than,” or “or more.”

While various aspects and embodiments have been disclosed herein, other aspects and embodiments are contemplated. The various aspects and embodiments disclosed herein are for purposes of illustration and are not intended to be limiting. Additionally, the words “including,” “having,” and variants thereof (e.g., “includes” and “has”) as used herein, including the claims, shall be open ended and have the same meaning as the word “comprising” and variants thereof (e.g., “comprise” and “comprises”).

1. A heat release foam, comprising:
a polymer foam body defining one or more outer surfaces disposed around an intermediate portion; and
a layer including graphene flakes located on at least one of the one or more outer surfaces, wherein the intermediate portion is substantially free of graphene flakes.

2. The heat release foam of claim 1, wherein the polymer foam body includes a polyurethane foam.

3. The heat release foam of claim 1, wherein the heat release foam exhibits a heat release of less than 50 kw Min/m² for at least two minutes under FAR 25.853 test conditions.

4. The heat release foam of claim 1, wherein the layer including graphene flakes includes graphene flakes having an average flake thickness of about 1 μm to about 100 μm.

5. (canceled)

6. The heat release foam of claim 1, wherein the layer including graphene flakes includes graphene flakes having an average largest dimension of about 50 μm to about 300 μm.

7. (canceled)

8. The heat release foam of claim 1, wherein the layer including graphene flakes include graphene flakes having a substantially planar conformation.

9. The heat release foam of claim 1, wherein the layer including graphene flakes include a plurality of randomly oriented graphene flakes.

10. The heat release foam of claim 1, wherein the layer including graphene flakes has a thickness of 5 mm or less.

11. A method of making a heat release foam, the method comprising:
applying a plurality of graphene flakes onto at least one molding surface of a mold;
depositing an uncured polyurethane foam in the mold; and
curing the polyurethane foam in the mold.

12. The method of claim 11, wherein applying a plurality of graphene flakes onto at least one molding surface of a mold includes spraying graphene flakes onto at least one molding surface of the mold.

13. The method of of claim 11, wherein applying a plurality of graphene flakes onto at least one molding surface of a mold includes spraying the plurality of graphene flakes onto the at least one molding surface in a solvent spray.

14. The method of of claim 11, wherein applying a plurality of graphene flakes onto at least one molding surface of a mold includes spraying graphene flakes onto all molding surfaces of the mold.

15. The method of of claim 11, wherein applying a plurality of graphene flakes onto at least one molding surface of a mold includes utilizing graphene flakes having one or more of an average flake thickness of about 1 μm to about 100 μm or an average largest dimension of about 50 μm to about 300 μm.

16. The method of of claim 11, wherein depositing an uncured polyurethane foam in the mold includes depositing a mixture of at least one isocyanate and at least one polyol into the mold.

17. The method of claim 16, wherein depositing an uncured polyurethane foam in the mold includes injecting the mixture into the mold.

18. The method of of claim 11, wherein curing the polyurethane foam in the mold includes allowing the polyurethane foam to expand to fill the mold.

19. The method of of claim 11, wherein curing the polyurethane foam in the mold includes controlling a temperature of the mold to a curing temperature.

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. A heat release controlled structure comprising at least one material having graphene flakes on an outer surface thereof and being substantially free of graphene flakes on a portion thereof interior to the outer surface.

58. The heat release controlled structure of claim 57 wherein the heat release controlled structure includes a heat release controlled foam having graphene flakes on an outer surface thereof and an interior portion that is substantially free of graphene flakes.

59. (canceled)

60. The heart release controlled structure of claim 57 wherein the heat release controlled structure includes one or more fiber layers having a plurality of fibers and a polymer resin disposed on the plurality of fibers.
